(19) United States
(12) Patent Application Publication
(10) Pub. No.: US 2024/0333880 A1
(43) Pub. Date: Oct. 3, 2024

(54) SYSTEMS AND METHODS FOR MONITORING URBAN AREAS

(71) Applicant: SenSen Networks Group PTY Ltd, Abbotsford, Victoria (AU)

(72) Inventors: Henry DETMOLD, Abbotsford (AU); Subhash CHALLA, Abbotsford (AU); Satish HRIT, Abbotsford (AU)

(73) Assignee: SenSen Networks Group PTY Ltd, Abbotsford, Victoria (AU)

(21) Appl. No.: 18/682,250

(22) PCT Filed: Aug. 9, 2022
(86) PCT No.: PCT/AU2022/050869

§ 371 Date: Feb. 8, 2024

(30) Foreign Application Priority Data
Aug. 10, 2021 (AU) 2021902481

(51) Int. Cl. H04N 7/18; G06F 1/28; G06V 10/80; G06V 20/52; G06V 40/16

(52) U.S. Cl. CPC H04N 7/181; G06F 1/28; G06V 10/80; G06V 20/52; G06V 40/16; H04N 7/188; G06V 2201/08

(57) ABSTRACT

The disclosure generally relates to systems and methods for monitoring urban areas or urban sensing. The disclosure also generally relates to sensing or monitoring platforms deployable in urban areas. The disclosure also generally relates to methods and systems for providing device networks in urban areas. Example embodiments include monitoring systems mounted or mountable on or in the top portions of poles so that camera sensors of the systems can be positioned to capture images of the urban areas. Example embodiments also relate to monitoring platforms including multiple such monitoring systems.

### TECHNICAL FIELD

The disclosure generally relates to systems and methods for monitoring urban areas or urban sensing. The disclosure also generally relates to sensing or monitoring platforms deployable in urban areas. The disclosure also generally relates to methods and systems for providing device networks in urban areas.

### BACKGROUND

Monitoring of urban environments may be required for various purposes. Such purposes may include urban management, safety, infrastructure management, environmental or resource use optimisation purposes, for example. Monitoring of urban environments may include monitoring of parking spaces, detection of traffic congestion, collection of statistical information regarding traffic or crowds, location beaconing, detection of infrastructure faults such as burst water mains, air quality monitoring, noise monitoring, vehicle or driver compliance monitoring, or temperature monitoring, for example.

As urban environments stretch over large geographical areas, manual monitoring of urban areas may be labour intensive, inefficient and may allow for slow response times. Conventional surveillance systems may require significant management or administration overhead, may not be scalable and may be expensive to deploy and maintain. There is a need to provide cost-effective, low latency and scalable urban monitoring systems, methods and platforms.

In this specification, a statement that an element may be “at least one of” a list of options is to be understood that the element may be any one of the listed options, or maybe any combination of two or more of the listed options.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

Some embodiments relate to a monitoring system comprising a post with an inner wall defining an elongate cavity, at least a top part of the elongate cavity receiving therein at least part of chassis, the chassis housing: a computing device; a communication subsystem accessible to the computing device to enable communication with a remote computing device; a first camera sensor in communication with the computing device and arranged to capture images of an area near the post; a power source configured to supply power to the computing device, the communication subsystem, and the first camera sensor; wherein the first camera sensor is configured to capture images and make the images accessible to the computing device.

In some embodiments, the power source comprises a battery and the battery is configured to supply power to the computing device, the communication subsystem, and the first camera sensor.

In some embodiments, the power source further comprises a solar panel, wherein the solar panel is disposed on or mounted to the post and configured to charge the battery.

In some embodiments, the computing device comprises an image data processing module to process the captured images and determine an edge computing output.

In some embodiments, the edge computing output is transmitted by the communication subsystem to the remote computing device.

In some embodiments, an orientation of the first camera sensor is configurable to vary a field of view of the first camera sensor.

In some embodiments, the system further comprises one or more of: an audio sensor, a temperature sensor, a humidity sensor, an air quality sensor, a ground vibration sensor, a soil moisture sensor, a motion detection sensor, a Bluetooth radio.

In some embodiments, the computing device is in communication with a low power sensor, wherein the low power sensor is configured to detect occurrence of an activity of interest; and responsive to the detection of occurrence of the activity of interest, the computing device is configured to initiate capture of images by the first camera sensor.

In some embodiments, the chassis further houses or is connected to a second camera sensor in communication with the computing device; wherein the first camera sensor is configured to capture images of a first field of view and the second camera sensor is configured to capture images of a second field of view.

In some embodiments, the first field of view partially overlaps with the second field of view; and the computing device is configured to perform data fusion operations on the images captured by the first camera sensor and the second camera sensor to determine an inference regarding an event of interest in the captured images.

In some embodiments, the inference regarding an event of interest in the captured images includes an inference of detection of an object.

In some embodiments, the object includes a vehicle and the inference further includes a vehicle identification number.

In some embodiments, the object includes a person and the inference further includes a face region of the person in an image captured by the first camera sensor or the second camera sensor.

In some embodiments, the first field of view is different from the second field of view.

Some embodiments relate to system for urban sensing, the system comprising a chassis housing: a computing device; a communication subsystem accessible to the computing device, the communication subsystem accessible to the computing device to enable communication with a remote computing device; at least a part of a camera sensor in communication with the computing device; at least a part of a power source configured to supply power to the computing device, the communication subsystem, and the camera; wherein the camera sensor is configured to capture images and make the images accessible to the computing device; and wherein at least a part of the chassis is configured to be received within an elongate cavity defined in a post.

In some embodiments, the chassis is slideably receivable in the elongate cavity while allowing the camera sensor to capture images of a vicinity of the post.

Some embodiments relate to a system for urban sensing, the system comprising: a first computing device in communication with a first communication subsystem and a first camera sensor, wherein the first camera sensor is provided on a first post; a second computing device in communication with a second communication subsystem and a second camera sensor, wherein the second camera sensor is provided on a second post; wherein the first and second communication subsystem enable communication between the first and second computing device; and wherein the first computing device is configured to receive data captured by the second camera sensor and perform data fusion operations using the data captured by the first camera sensor and the data captured by the second camera sensor.

Some embodiments relate to a method of providing a kerbside communication network, the method comprising: providing a plurality of systems for urban sensing in a plurality of posts on a kerbside; wherein a communication subsystem of each of the plurality of systems for urban sensing is configured to communicate with at least one proximate communication subsystem provided in an adjacent post.

Some embodiments relate to a system for urban sensing, the system comprising: a first post and a second post adjacent to the first post; a first camera sensor provided in the first post and a second camera sensor provided in the second post; a computing device configured to receive images from the first camera sensor and the second camera sensor; wherein the first camera sensor captures images of a first field of view, and the second camera captures images of a second field of view; wherein the first field of view partially overlaps with the second field of view; wherein the computing device is configured to process the images received from the first camera sensor and the second camera sensor and perform data fusion operations of the received images to determine an inference regarding an activity of interest in the received images based on an output of the data fusion operations.

The monitoring system of some embodiments further comprises a watchdog component, the watchdog component being configured to: receive power supply status signals from the power source; and control supply of power to the computing device responsive to the received power supply status signals.

The monitoring system of some embodiments further comprises a watchdog component, the watchdog component being configured to: receive computing device status signals from the computing device; process the received computing device status signals to determine a functional status of the computing device; and transmit a reset signal to the computing device responsive to determining that the functional status of the computing device indicates a malfunction.

The monitoring system of some embodiments further comprises a watchdog component, the watchdog component being configured to: receive temperature data from the temperature sensor or humidity data from the humidity sensor; process the received temperature data or humidity data to determine a temperature or humidity condition unsuitable for the operation of the computing device; and terminate supply of power to the computing device responsive to the determination of the condition unsuitable for the operation of the computing device.

Some embodiments relate to a method of urban monitoring, the method comprising: providing the monitoring system of any one of the described embodiments in an urban area; capturing images from a camera sensor of the monitoring system; processing the captured images by the computing device of the monitoring system to perform urban monitoring. In some embodiments, processing the captured images comprises processing to detect objects of interest in the captured images.

Some embodiments relate to a method of urban monitoring, the method comprising: providing the monitoring system of any one of the described embodiments in an urban area; capturing images from a camera sensor of the monitoring system; transmitting captured images to a remote computing device via the communication subsystem.

Some embodiments relate to kits for assembling one or more monitoring systems as described herein. Such embodiments include, for example, a chassis or housing that houses or carries: a computing device; a communication subsystem accessible to the computing device, a camera sensor in communication with the computing device; and a power source configured to supply power to the computing device, the communication subsystem, and the first camera sensor.

### BRIEF DESCRIPTION OF FIGURES

Exemplary embodiments are illustrated by way of example in the accompanying drawings in which like reference numbers indicate the same or similar elements and in which:

FIG. 1 is a schematic diagram of an exemplary monitoring system installed on a post;

FIG. 2 is a schematic diagram of an exemplary monitoring platform comprising two monitoring systems of FIG. 1;

FIG. 3 is a block diagram of an exemplary monitoring platform;

FIG. 4 is a schematic diagram of an exemplary monitoring system;

FIGS. 5 and 6 are flow charts illustrating methods of urban monitoring implemented by the exemplary system of FIG. 1;

FIGS. 7 and 8 are flow charts of methods of urban monitoring implemented according to some embodiments; and

FIG. 9 is a block diagram of an exemplary monitoring system illustrating interactions of a watchdog component with other components of the monitoring system.

### DETAILED DESCRIPTION

This disclosure generally relates to systems and methods for monitoring urban areas or urban sensing. The disclosure also generally relates to sensing or monitoring platforms deployable in urban areas. The disclosure also generally relates to methods and systems for providing urban device networks

The embodiments include systems, methods, communication platforms and networks for urban monitoring or surveillance. The embodiments may include systems that can be retrofitted or integrated into pre-existing urban fixtures. The pre-existing urban fixtures may include posts, parking signs, traffic lights, public transport shelters such as bus stops, public transport signs or posts, lights posts or rubbish bins, for example. The embodiments may comprise a computing device in communication with various sensors including a camera sensor, audio sensor, temperature sensor, humidity sensor, light sensor, air quality sensor, ground vibration or seismic sensor, soil moisture sensor, motion detection sensor, etc. The computing device may receive sensor data and perform computations or operations on the received sensor data to enable monitoring operations. Retrofitting or integration of the systems of the embodiments in urban fixtures provides a cost-efficient mechanism for deploying the monitoring system across an urban area without requiring extensive deployment works such as mounting or new posts or affixation works on buildings, for example. Retrofitting or integration of the systems of the embodiments in urban fixtures maximizes the value of existing assets in urban areas as well.

In some embodiments, a part of the monitoring system may comprise a chassis to hold or carry the various components of the monitoring system. A part of the chassis or a part of the system may be provided inside a cavity of an urban fixture such as a post. Parts of the monitoring system requiring exposure to the environment may be positioned on or in the chassis or positioned in relation to the chassis to have access to the relevant environment. The embodiments accordingly maximise the value of pre-existing urban fixtures while providing a monitoring or sensing system that had adequate access to the relevant urban environment to capture the relevant data.

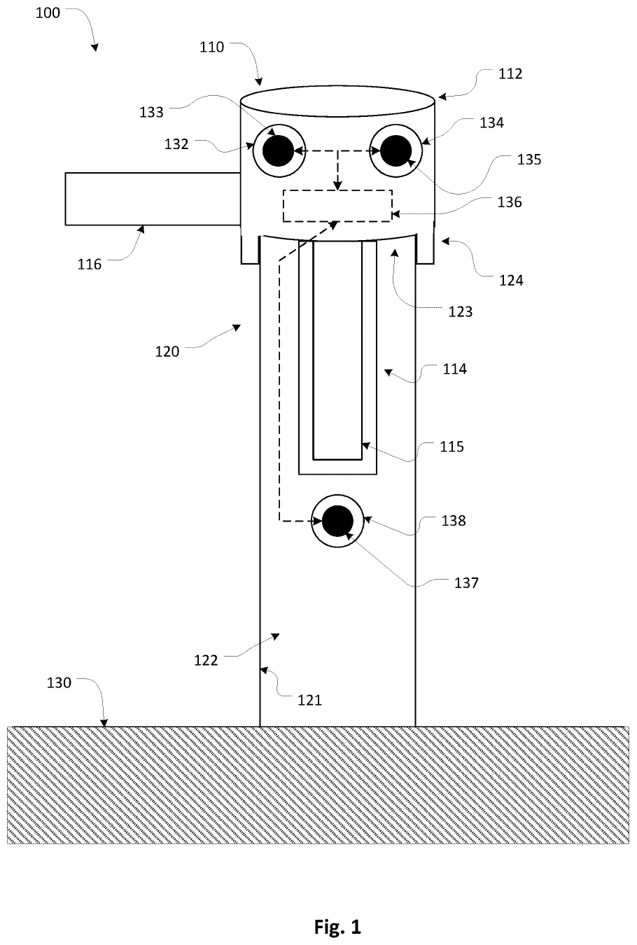

FIG. 1 is a schematic diagram of an exemplary monitoring system 100 comprising a post. FIG. 1 illustrates a partial section view of a post 120. The post 120 may have a hollow interior that is defined by a wall 121, such as a cylindrical wall, for example. In some embodiments, the post 120 may have a square cross-section, or a hexagonal cross-section or any other suitable cross-section. Post 120 may be a parking signpost, a traffic light post, a post (or other structure) that is part of a public transport shelter such as a bus stop, a public transport signpost, or a light post, for example. The post 120 may be fixed to the ground 130 in an urban environment. In some embodiments, post 120 may be or include a metal post defined by one or more metal walls.

Within post 120, there may be a cavity 122, such as a cylindrical cavity, defined by the wall 121. The cavity 122 may be accessible from a top part 123 of the post 120. When not used as part of the monitoring system of the embodiments, the top part 123 of the post 120 may be covered with a cap or may be left open. During a retrofitting process, the top part 123 of the post 120 may be opened and a body or chassis 110 may be affixed on the top part 123 of the post 120. The chassis 110 may be or comprise a housing to house sensors, such as cameras, and at least part of the system power supply and electronics for operating the monitoring system 100. The housing may include sub-housings or housing parts. For example, a sub-housing may house one or multiple batteries, while a separate sub-housing may house sensors and processing electronics.

The chassis 110 may comprise a top or an upper part 112 and a bottom or a lower part 114. At least a part of the lower or bottom part 114 is received in the cavity 122 of the post 120. The top part 112 may comprise a sleeve or rim 124 that allows the chassis 110 to be fitted on the top part 123 of the post 120 without falling into the cavity 122. The sleeve or rim 124 may conform to the shape of the top part 123 to allow the chassis 110 to be received in a location fit or an interference fit, for example. The chassis 110 is fixed on top of post 120 with sufficient friction and/or other fixation mechanisms to keep it stable during operation and tolerant of vibrations or movement. However, the chassis 110 may be removed or decoupled from the post 120 for maintenance operations to its various components.

The lower part 114 of the chassis 110 may extend through a part or whole of the length of the cavity 122 of the post 120. In some embodiments, the lower part 114 may house a battery pack 115. Owing to the length on the post 120, a number of individual batteries may be provided in the battery pack 115 to power the electronic components of the monitoring system 100. For example, the battery pack 115 may include a single battery or multiple batteries, such as between 2 and 20 batteries, of a commercially available type. With a suitable number of batteries provided in the battery pack 115, the electronic components of the monitoring system 110 may not require any power related maintenance for a significant period, such as multiple months. In some embodiments, the monitoring system 100 may comprise a solar panel 116 affixed to the chassis 110 or a part of the post 120. Solar panel 116 may be configured to charge rechargeable batteries provided in the battery pack 115 to further reduce the need for maintenance actions, such as the replacement of batteries. In some embodiments, more than one solar panel 116 may be provided as part of the monitoring system 100. The battery pack 115 may be configured to be modularly augmented with additional batteries to support an increase in the power consumption by the components of the monitoring system 100.

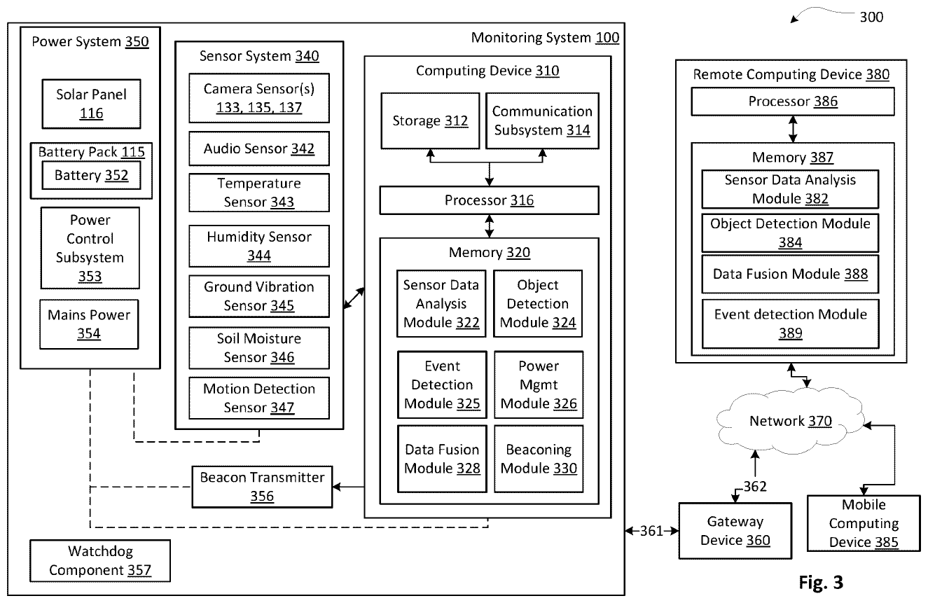

The top part 112 of the chassis 110 may comprise a first window or aperture 132. The aperture 132 may provide a clear external line of sight for a camera sensor 133 provided inside the chassis 110. In some embodiments, there may be provided a second window or aperture 134 to provide an external line of sight for a second camera sensor 134 provided in the chassis 110. With the two camera sensors 133 and 135, the monitoring system 100 is capable of monitoring activity in distinct fields of view at particular angles with respect to post 120. The fields of view of the camera sensors 133, 135 may be partially overlapping or non-overlapping, for example. For example, the monitoring system 100 may be configured with two camera sensors that may together monitor a sector of an angle approximating 360 degrees or 240 degrees or 180 degrees. In embodiments where the post 120 is a kerbside signpost in the vicinity of a parking lot, two camera sensors provided in the chassis 110 may allow the monitoring of the use of parking lots in the vicinity of the signpost. In some embodiments, the camera sensors provided in the chassis may also be angled to allow the monitoring of activity on the pavement or sidewalk adjacent to the post. The apertures 132, 134 may be so positioned to allow capturing images of a direction or angle of interest for monitoring purposes. In some embodiments, three or four or more apertures may be provided on chassis 110 to allow for the inclusion of additional camera sensors to acquire images from additional angles to monitor activities or to obtain redundant imaging data for verification purposes. Also provided in chassis 110 is an electronics enclosure 136 for storing a computing device 310, which is illustrated in more detail in FIG. 3.

In some embodiments, there may be provided an aperture 138 in a body of the post 120 to provide a field of view to a further camera sensor 137 housed in the post 120 at a location apart from camera sensor 133 or 135. The further camera sensor 137 may be configured to capture images from a lower level in comparison to camera sensors 133 and 135. The field of view of the camera sensors 137 may be partially overlapping or non-overlapping with the fields of view of either of camera sensors 133, 135, for example.

The aperture 138 and camera sensor 137 may be provided at a height of between 50 cm to 250 cm as measured from the ground level 130 next to the post 120, for example. The further camera sensor 137 may capture images of the urban area from a different perspective in comparison to the camera sensors 133 and 135. The apertures 132 and 134 may be provided at a height of 250 cm to 500 cm, for example. In some embodiments, additional apertures may be provided in the post 120 to position camera sensors at various heights and angles with respect to the post 120 to capture images from different perspectives. A diversity of cameras with various complementary lines of sight may be provided in the post 120 to capture images of the surroundings of the post. A combination of a diversity of cameras at various heights and lines of sight may enable a more comprehensive gathering of image data of the vicinity of the post 120 to improve the comprehensiveness of the monitoring operations based on the captured image data.

In some embodiments, a zoom level of the camera sensors 133, 135 and 137 may be varied or adjusted to meet changing requirements for gathering image data. In some embodiments, the line of sight or angle of view of the camera sensors 133, 135 and 137 may be varied or adjusted to meet changing requirements for gathering image data.

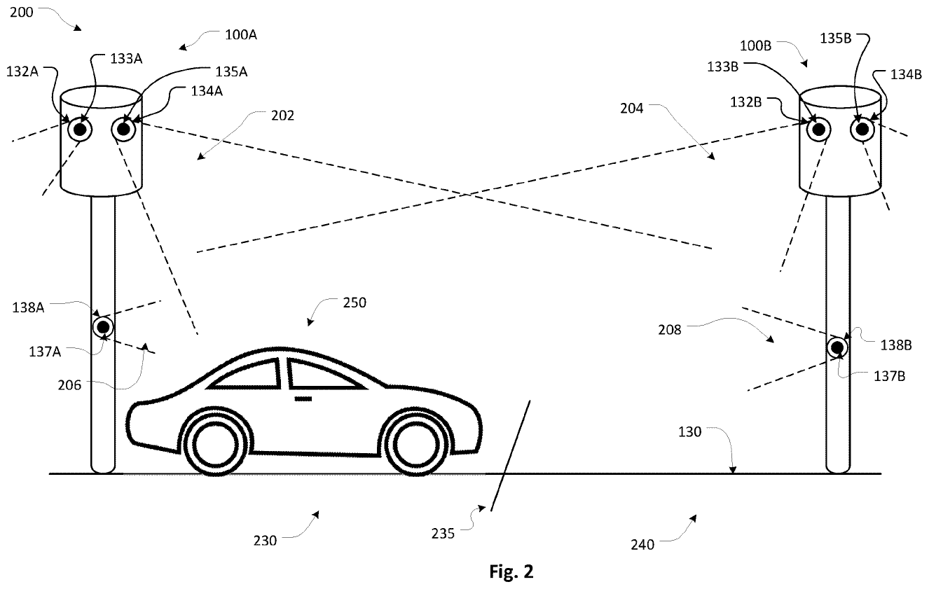

FIG. 2 is a schematic diagram of an exemplary monitoring platform 200 comprising two monitoring systems 100, labelled 100A and 100B for ease of reference. Each monitoring system 100A, 100B is positioned on or near a kerbside or urban location to monitor parking lots or spaces located adjacent to the posts. System 100A comprises apertures 132A and 134B allowing respective different fields of view 202 and 204 for camera sensors 133A and 135A provided in the system 100A to monitor the vicinity of the respective post 120. Similarly, system 100B comprises apertures 132A and 134B to provide different fields of view 202, 204 to camera sensors 133B and 135B.

In FIG. 2, two demarcated areas, illustrated in this example as parking spaces 230 and 240, are located between posts 210 and 220. The parking spaces 230 and 240 may be demarcated or delineated by one or multiple markings or separators 235. Camera sensors 132A, 134B, 133B. 135B provided in systems 100A, 100B may be configured to monitor the use of the parking spaces 230 and 240. Monitoring systems 100A and 100B may be configured to periodically capture images of the parking spaces. The captured images may be processed by processor 316 (FIG. 3) to identify vehicles or other objects in a field of view of the respective camera sensor 133, 135, 137. Fields of views of the camera sensors in the same post 120 or in different (i.e. adjacent) posts 120 may partially overlap to allow the capture of image data of a specific area from distinct viewpoints or angles. For example, camera sensor 135A of system 100A has a field of view 202 that overlaps with a field of view 204 of camera 133B of system 100B.

In some embodiments, there may be provided in post 100A an aperture 138A for a reference camera sensor 137A. Camera sensor 137A may have a field of view or line of sight 206. In some embodiments, there may be provided in post 100B an aperture 138B for camera sensor 137B. Camera sensor 137B may have a field of view or line of sight 208 that is different from the field of view or line of sight 206. Depending on the nature of the monitoring operations, the height and fields of views of the camera sensors 133A, 135A, 133B, 135B, 137A, 137B may be different to capture images more suitable for the monitoring operation. In some embodiments, additional apertures or cameras may be provided in posts 100A or 100B to capture images for performing the monitoring operations. The combination of the various camera sensors illustrated in FIG. 2 may enable capture of image data of an activity of interest in the event of partial or total occlusion of a subset of the camera sensors. For example, if for some reason camera sensor 137B is occluded and is unable to capture images of vehicle 250, then images captured by camera sensor 137A may enable observation or monitoring of vehicle 250.

In several urban areas, a parking area is often designated by the presence of posts at two ends of a parking area. The embodiments of system 100 may accordingly be retrofitted in posts defining the two ends (and possibly also in or on posts or other structures intermediate those two ends) of a parking area to leverage existing physical infrastructure. Data fusion operations may be performed using the images captured by the various cameras illustrated in FIG. 2 to obtain a more accurate inference regarding activities of interest or objects of interest in the urban area under observation.

Identification of vehicles may include identification of a vehicle registration number, or a vehicle make or model or a vehicle colour, for example. Data recorded and stored along with the captured images may comprise timestamp information for each captured image, for example. Based on the timestamp information and captured images, compliance of a vehicle with various time-based parking conditions may be determined.

FIG. 3 is a block diagram of an exemplary monitoring platform 300 according to some embodiments. Illustrated in FIG. 3 is a monitoring system 100 in communication with a gateway device 360. The gateway device 360 may be in communication with a remote computing device 380 over a communication network 370. Monitoring platform 300 may comprise multiple monitoring systems 100 deployed in an urban area. Each monitoring system 100 may be in communication with at least one gateway device 360. Monitoring platform 300 may comprise multiple gateway devices 360, each gateway device 360 serving as a backhaul for a group of adjacently located monitoring systems 100. Using this architecture, monitoring platform 300 may be scaled to include tens, hundreds or thousands of monitoring systems 100, for example. Further, multiple monitoring platforms 300 may be in communication with each other to share data or computational resources.

The monitoring system 100 may comprise a computing device 310 in communication with sensor system 340. The monitoring system 100 may further comprise a power system 350 to provide power to the computing device 310 and the sensor system 340. The computing device 310 may comprise or be implemented using a microcontroller, a small form factor computing device, a system on chip computing device, or a smartphone, for example.

The computing device 310 comprises a processor 316 in communication with a memory 320, a communication subsystem 314 and storage media 312. Memory 320 may comprise program code executable by the processor 316 to perform sensor data processing or monitoring operations on the sensor data. The program code of memory 320 may be updateable by firmware updates received from the remote computing device 380. For example, the remote computing device 380 may transmit program code that may be received by the computing device 310 and executed by processor 316. Storage media 312 may comprise non-volatile memory that may store program code retrievable by the processor 316 for execution in coordination with memory 320. Storage media 312 may also comprise data or observations or results of data processing operations performed by the processor 316. Storage media 312 may be implemented using a magnetic or solid-state hard disk, or removable storage such as an SD card. In some embodiments, the computing device 310 may be implemented using an edge microcontroller, for example.

The communication subsystem 314 may comprise hardware, software or a combination of hardware and software to enable communication between the computing device 310 and the gateway device 360. The communication subsystem 314 may include a WiFi adapter or a Bluetooth radio or other short-range wireless communication hardware and relevant firmware to enable communication between the gateway device 360 and the computing device 310.

The memory 320 comprises program code implementing: a sensor data analysis module 322, an object detection module 324, an event detection module 325, a power management module 326, a data fusion module 328 and a beaconing module 330. The various modules in memory 320 implement data processing and communication functionality to perform monitoring based on the data generated by the sensor system 340 or coordinate with other monitoring systems to verify or validate the observations or inferences determined by the monitoring system 100. The observations or inferences determined by the monitoring system 100 may be referred to as edge computing outputs.

The sensor data analysis module 322 may comprise program code to receive and process the data generated by the sensor system 340. The sensor data analysis module 322 may perform pre-processing operations on the received sensor data. For example, in embodiments where the received sensor data includes image data from the camera sensor 133, 135 or 137, the sensor data analysis module 322 may perform image pre-processing operations to allow the image data to be processed by the object detection module 324, for example.

The object detection module 324 may comprise program code to analyse camera sensor data and perform object detection operations on the camera sensor data. Objects detected by the object detection module 324 may comprise: persons, faces, cars, license plates of cars, vehicles, vehicle identifiers such as license plates, dumped objects, for example. The object detection module 324 may also be trained to determine an outline or segment in an image captured by the camera sensor 133, 135 or 137 that corresponds to a detected object. An outcome of the object detection process performed by the object detection module 324 may be or include information regarding a class to which each identified object belongs and information regarding the location or region in an image corresponding to the detected object. The location of identified objects may be indicated by image coordinates of a bounding box surrounding a detected object, for example. The outcome of object detection may also comprise a probability number associated with a confidence level of the accuracy of the class of the identified object, for example. The object detection module 324 may comprise program code to identify a vehicle, such as a car, truck, motorcycle or bicycle, or a person, a face or a specific body part of a person in an image, for example.

In some embodiments, the object detection module 324 may be configured to process an image received from the camera sensor 133 or 135 and determine whether or not there are instances of objects of interest from predefined categories and, if present, to return the spatial location and extent of each instance. In some embodiments, the object detection module 324 may comprise a neural network trained to process image data received from the camera sensor 133, 135 or 137 and detect the presence of objects from among predefined categories of objects. The neural networks of the object detection module 324 may be trained using a training dataset comprising training images. Corresponding to each training image, the training data may comprise class or label information identifying all instances of objects of interest in the training image. The training data may also comprise co-ordinate information associated with a region, segment or a bounding box corresponding to each object of interest in each training image.

The object detection module 324 may incorporate a region-based convolutional neural network (R-CNN) or one of its variants including Fast R-CNN or Faster-R-CNN or Mask R-CNN, for example, to perform object detection. The R-CNN may comprise three modules: a region proposal module, a feature extractor module and a classifier module. The region proposal module is trained to determine one or more candidate bounding boxes around potentially detected objects in an input image. The feature extractor module processes parts of the input image corresponding to each candidate bounding box to obtain a vector representation of the features in each candidate bounding box. The classifier module may process the vector representations to identify a class of the object present in each candidate bounding box. The classifier module may generate a probability score representing the likelihood of the presence of each class or objects in each candidate bounding box. For example, for each candidate bounding box, the classifier module may generate a probability of whether the bounding box corresponds to a person or a game object.

Based on the probability scores generated by the classifier module and a predetermined threshold value, an assessment may be made regarding the class of objects present in the bounding box. In some embodiments, the classifier may be implemented support vector machine. In some embodiments, the object detection module 324 may incorporate a pre-trained ResNet based convolutional neural network (for example ResNet-50) for feature extraction from images to enable the object detection operations.

In some embodiments, the object detection module 324 may incorporate a you look only once (YOLO) model for object detection. The YOLO model comprises a single neural network trained to process an input image and predict bounding boxes and class labels for each bounding box directly. The YOLO model splits an input image into a grid of cells. Each cell within the grid is processed by the YOLO model to determine one or more bounding boxes that comprise at least a part of the cell. The YOLO model is also trained to determine a confidence level associated with each bounding box, and object class probability scores for each bounding box. Subsequently, the YOLO model considers each bounding box determined from each cell and the respective confidence and object class probability scores to determine a final set of reduced bounding boxes around objects with an object class probability score higher than a predetermined threshold object class probability score.

Inferences or results generated by the object detection module 324 may trigger detection or identification of events by the event detection module 325. The event detection module 325 may comprise program code implementing the program logic to identify events based on the output of the object detection module 324 and/or the sensor data analysis module 322.

For example, in some embodiments the monitoring system 100 may be configured to perform parking monitoring in an urban area. The computing device 310 may be configured to periodically receive image data corresponding to a designated parking area from the camera sensor 133 or 135. The object detection module 324 may be configured to process the image data to detect the presence of vehicles. The object detection module 324 may also be configured to detect a license plate corresponding to a detected vehicle and perform character recognition operations to determine the license plate number. The object detection module 324 may transmit the output of the object detection operation to the event detection module 325. The event detection module 325 based on the input may determine the occurrence of a parking event or an event corresponding to the initiation of the parking of a vehicle (parking entry event). The event detection module 325 may record a timestamp associated with the event or the time associated with the capture of the image as the time corresponding to the parking event, for example.

The object detection module 324 may continue to analyse subsequently captured images to detect objects in the captured images and transmit the object detection output to the event detection module 325. The event detection module 325 may analyse the object detection output to determine whether the previously detected vehicle is not detected anymore. If the previously detected vehicle is not detected anymore, then the event detection module 325 may record an event corresponding to the exit of the previously detected vehicle from a parking space (parking exit event). The event detection module 325 records timestamp information and parking space identifier information associated with the parking exit event. Data relating to the parking entry and exit events may together enable determination of compliance of a vehicle with parking conditions or regulations associated with a parking space.

The object detection module 324 and the event detection module 325 may together be configured to perform various monitoring operations including congestion detection on roads, vehicle movement or passage counting operations, person movement counting operations, for example.

The power management module 326 may comprise program code to optimise the power consumed by the monitoring system 100. The power management module 326 may generate control signals to turn on or off or vary a configuration of one or more components of the sensor system 340. For example, the power management module 326 may be configured according to a predetermined schedule to turn on and off one or more of the sensors of the sensor system 340 to obtain sensor data or observations based on the predetermined schedule. In some embodiments, the power management module 326 may be configured to generate control signals to control (i.e. turn on or off) a first sensor based on sensor data received from a second sensor. For example, if a motion detection sensor generates data indicating motion in the vicinity of the sensor system, then the power management module 326 may be configured to send a control signal to the camera sensor 133, 135 or 137 to initiate capture of images in response to the sensor data indicating motion.

Optimisation of power consumption by the sensor system 340 may allow the monitoring system 100 to operate with less power supply related manual interventions. For example, in embodiments where the monitoring system 340 is configured to operate on battery based power, the optimisation of power consumption may reduce the frequency of replacement of the batteries of the monitoring system 100. With multiple instances of the monitoring system 100 deployed across a large urban area, the benefits of optimisation of power consumption by each monitoring system 100 may be significant.

The data fusion module 328 may comprise program code to perform data fusion operations by the monitoring system 100. Data fusion includes computational operations to combine data from multiple sources for achieving a better and more accurate understanding of an activity or phenomenon of interest. The data from multiple sources for data fusion may include data from each sensor of the sensor system 340. The data from multiple sources from data fusion may include data from distinct monitoring systems 100.

Sensor data obtained from the various sensors of the sensor system 340 may each have varying levels of accuracy and varying coverage of areas or environments observed. The variations in accuracy and coverage further expand as sensor data generated by multiple monitoring systems 100 disposed in a large urban area are taken into account.

For example, the single camera sensor 133 included in a monitoring system 100 may not provide complete information with respect to a scene or area that is being monitored or observed. Each camera sensor, such as camera sensors 133, 135 or 137, may have a different field of view and different camera sensors, such as infrared camera sensors and optical camera sensors, and/or may have different resolution capabilities and spectrum observation. More accurate and credible inferences regarding an observed environment may be obtained when data from various sensors are combined.

For data fusion of imaging data, fusion of image data may be done at various levels including: at pixel level, at feature level, or at a decision level. Pixel level data fusion may include fusion of image data corresponding to one or more pixels of image data captured by distinct camera sensors. Pixel-level fusion operation methods include Laplacian pyramid, discrete wavelet transforms, and support vector machines based data fusion, for example.

Feature level data fusion may include fusion of data relating to features detected in image data, for example, features detected by the object detection module 324 in the process of object detection. Decision level data fusion may include fusion of data relating to decisions or inferences made in relation to image data. The decisions or inferences may include inferences in relation to objects detected by the object detection module 324. The decisions or inferences may include inferences in relation to an activity of interest observed in images captured by one or more camera sensors. The decisions or inferences may be referred to as edge computing outputs.

Performing monitoring and sensing operations using a network of monitoring systems 100 dispersed in a large urban area may require distributed data processing at respective deployment sites of each monitoring system 100. Although each monitoring system 100 may process sensed image data to make inferences regarding the presence or absence of an object or a phenomenon of interest in the image data, in some embodiments a final determination may be based on the collective information obtained from more than one monitoring system 100. In some embodiments, a particular monitoring system 100 may operate as a central site or a data fusion centre associated with a part of a monitored urban area. The monitoring system 100 operating as a data fusion centre may receive information including image data and/or object detection output data from proximate monitoring systems 100, such as those monitoring systems 100 that are serviced by the same gateway device 360 as the data fusion centre. Based on the received data, the monitoring system 100 operating as a data fusion centre may perform data fusion operations and make a final decision regarding an object detection inference, or a monitoring event or an observed phenomenon of interest, for example.

In some embodiments, the monitoring system 100 may be configured to operate as a beacon. The beaconing module 330 may operate in coordination with the communication subsystem 314 and the beacon transmitter 340 to perform beaconing operations. In some embodiments, the beacon may be a human perceptible beacon including a visible light or a sound to attract attention. In some embodiments, the beacon may be directed towards machines and may include a Bluetooth based beacon, a non-visible spectrum light beacon or an ultrasonic beacon. The beacons may communicate to observers or machines the occurrence of an event or phenomenon of interest. For example, in embodiments wherein the monitoring system is configured to perform monitoring of the use of parking spaces, the beacon may indicate a violation of parking conditions based on the observed and processed sensor data from the sensor system 340. The beacon transmitter 340 may include a visible light source, or a speaker system to generate audio transmissions, or a Bluetooth or other radio frequency transmitter, a non-visible spectrum light source or an ultrasonic sound source, or a combination of two or more aforementioned components.

The sensor system 340 may comprise one or more sensors to observe the surroundings of the monitoring system. The sensor system may comprise camera sensor 133. The camera sensor 133 may capture images of the surroundings of the monitoring system 100. The camera sensor 133 may capture images in a visible spectrum or images in the infrared spectrum or images within specific wavelength ranges across the electromagnetic spectrum (multispectral imaging).

The sensor system 340 may comprise one or more audio sensors 342 to capture ambient audio from the vicinity of the monitoring system 100. The sensor system 340 may comprise one or more temperature sensors 343 to capture temperature data. The sensor system 340 may comprise one or more humidity sensors 344 to capture air humidity data. The sensor system 340 may comprise a ground vibration sensor or geophone 345 to capture ground vibration data. A part of the ground vibration sensor 345 may be installed underground to allow the ground vibration sensor or geophone 345 to make observations regarding the movement of the ground. In embodiments where the monitoring system 100 is mounted on a post, the ground vibration sensor or geophone 345 may be positioned within the cavity of the post to secure the ground vibration sensor or geophone 345. Data from the ground vibration sensor or geophone 345 may be indicative of or a proxy for vehicular traffic in the proximity of the monitoring system 100. In some embodiments, the ground vibration sensor or geophone 345 may be positioned outside of the post at a desirable location near the intended area to be monitored. The ground vibration sensor or geophone 345 may be configured to communicate the ground vibration data wirelessly or through a secured wire to the computing device 310.

The sensor system 340 may comprise a soil moisture sensor 346 that may be configured to sense soil moisture levels. Similar to the ground vibration sensor 345, the soil moisture sensor 346 may be partially mounted in the ground. In embodiments wherein the monitoring system 100 is mounted on a post, the soil moisture sensor 346 may be positioned within the cavity of the post to secure the soil moisture sensor 346. In some embodiments, the soil moisture sensor 346 may be positioned outside of the post at a desirable location near the intended area to be monitored. The soil moisture sensor 346 may be configured to communicate the ground moisture data wirelessly or through a secured wire to the computing device 310.

The sensor system 340 may also comprise a motion detection sensor 347 to detect motion in the vicinity of the monitoring system. The motion detection sensor 347 data may be used by the computing device 310 to trigger turning on and off other sensors of the sensor system 340, for example.

The monitoring system 100 also comprises a power system 350 to provide power to the computing device 310, the sensor system 340 and the beacon transmitter 356. The power system 350 may comprise one or more solar panels 116, a battery pack 115 including at least one battery 352, and/or optionally a mains power supply 354 where available. The battery 352 may be a rechargeable battery that may be charged by the power harvested by the solar panel 116 (if the solar panel 116 is present). The power system 350 may also comprise a power control subsystem 353 to control the transmission of power to the rest of the components of the monitoring system 100 or to manage and control charge levels of the battery 352, for example.

The monitoring system 100 may be configured to communicate sensed data, inferences based on the sensed data, detected events or other observations or output of data processing operations to the remote computing device 380 through the gateway device 360 over the network 370. The gateway device 360 may comprise hardware and or software to enable communication between network 370 and each computing device 310 deployed in an urban area. The gateway device 360 may communicate using a wired or wireless link 361 with the computing device 310. In some embodiments, the gateway device 360 may communicate with the computing device 310 using any one or more of: Z-Wave, ZigBee, WirelessHART, Wi-Fi, Weighless, SigFox, NB-IoT, Long-Term Evolution (LTE), LoRa, Bluetooth, 2G, 3G, 4G, 5G or 6G communication protocols or networks, for example. In some embodiments, the gateway device 360 may communicate with the computing device 310 using a wired Ethernet link, a fibre optic cable link, a USB link, or a wired USB link, for example.

In some embodiments, the communication link 361 may be an intermittent (or non-persistent) communication link. An intermittent communication link 361 may be implemented to optimise or reduce the power consumption by computing device 310 and/or gateway device 360. In embodiments where communication link 361 is an intermittent communication link, data or results of data processing operations by the computing device 310 may be stored in storage 312 or memory 320 until the communication link 361 is available for transmission. Similarly, data or instructions from gateway device 360 directed to computing device 310 may be stored in a memory or storage of the gateway device until link 361 is restored to allow the transmission of the data or instructions to the computing device 310. The gateway device 360 may communicate with network 370 using a wired or wireless communication link 362 that may include one or more of: a 2G, 3G, 4G, 5G or 6G communication link, wired Ethernet link, or a wired telephony link, or a Wi-Fi link, for example.

The network 370 may include, for example, at least a portion of one or more networks having one or more nodes that transmit, receive, forward, generate, buffer, store, route, switch, process, or a combination thereof, etc. one or more messages, packets, signals, some combination thereof, or so forth. The network 370 may include, for example, one or more of: a wireless network, a wired network, an internet, an intranet, a public network, a packet-switched network, a circuit-switched network, an ad hoc network, an infrastructure network, a public-switched telephone network (PSTN), a cable network, a cellular network, a satellite network, a fiber optic network, some combination thereof, or so forth.

In some embodiments, a part or whole of the computational operations performed by the computing device 310 may be performed by the remote computing device 380. The remote computing device 380 may comprise a processor 386 in communication with a memory 387. The memory 387 may comprise program code to implement a sensor data analysis module 382, an object detection module 384, a data fusion module 388 and an event detection module 389. The various modules of the remote computing device 380 may perform part or all of the data processing operations described with reference to the sensor data analysis module 322, an object detection module 324, a data fusion module 328 and an event detection module 325 of the computing device 310. The computational operations for the processing of the data obtained from the sensor systems 340 and determination of inferences based on the sensor data may be distributed across more than one computing device 310 and the remote computing device 380.

In some embodiments, the monitoring platform 300 further comprises a mobile computing device 385. The mobile computing device 385 may be a handheld computing device configured to wirelessly communicate over network 370, for example. The mobile computing device 385 may be held by a parking enforcement officer and may be configured to receive alerts regarding parking condition non-compliance from the remote computing device 380 or the computing device 310, for example.

The various components of the monitoring system 100 may comprise hardware and/or software components to improve one or more of: the reliability, availability, dependability, and maintainability of the various components of the monitoring system 100. The various components of the monitoring platform 300 may comprise hardware and/or software components to improve one or more of: the reliability, availability, dependability, and maintainability of the various components of the monitoring platform 300.

Within the monitoring system 100 there may be provided a watchdog component 357. The watchdog component 357 may be housed in a same housing as the computing device 310 or another housing part located close to the computing device 310, for example. The watchdog component 357 may comprise electronic circuitry to receive operational status data from one or more of: the power system 350, the sensor system 340, the computing device 310, and the beacon transmitter 356. The operational status data may comprise data regarding the functional status of the components. The functional status data may comprise an indication of a normal function or a malfunction of a component, for example.

The watchdog component 357 may also be configured to transmit control signals to the various components of the monitoring system 100. The transmission of control signals may enable the watchdog component 357 to configure or update one or more control parameters of the various components of the monitoring system 100. The transmission of control signals by the watchdog component 357 may be performed responsive to the received operational status data.

In some embodiments, the watchdog component 357 may be configured to transmit a control signal to reboot or reset one or more of the components of the monitoring system 100 in response to the received operational status data indicating a malfunction of a particular component of the monitoring system 100. In some embodiments, the watchdog components 357 may comprise a watchdog timer or a computer operating properly (COP) timer to detect malfunctions within the monitoring system 100 and recover from malfunctions.

In some embodiments, the watchdog component 357 may comprise an adaptive watchdog configured to analyse the received operational status data and generate adaptive control signals responsive to the received operational status data. In some embodiments, the watchdog components 357 may be configured to reboot the computing device 310 in response to operational status data received from the power system 350 indicating low power supply or low power stored in the battery 352.

Implementation of the watchdog component 357 advantageously reduces the need for onsite repair of components. With the monitoring platform 300 distributed over a large urban area, reducing the need for repair of the various monitoring systems 100 deployed across the urban area provides the significant advantage of the reduced need for manual repair and improves the availability and dependability of the monitoring platform 300.

The monitoring platform 300 provides a monitoring solution or service that is of higher dependability. The monitoring capability of the monitoring platform 300 is configured to avoid or reduce failures of individual components and continue to provide a monitoring capability over a wide urban area despite failure or malfunctions in individual components within the monitoring platform 300. The monitoring platform 300 is also configured to continue to provide monitoring capability despite the failure of a subset of components within the monitoring platform 300.

Individual components within the monitoring platform 300 may be repaired or updated or disabled without affecting the operations of the rest of the components of the monitoring platform 300. For example, a single monitoring system 100 may malfunction or fail to operate, without affecting other monitoring systems 100 within the monitoring platform 300. Similarly, one sensor within the sensor system 340 may malfunction without affecting the operation of the rest of the sensors within the sensor system 340.

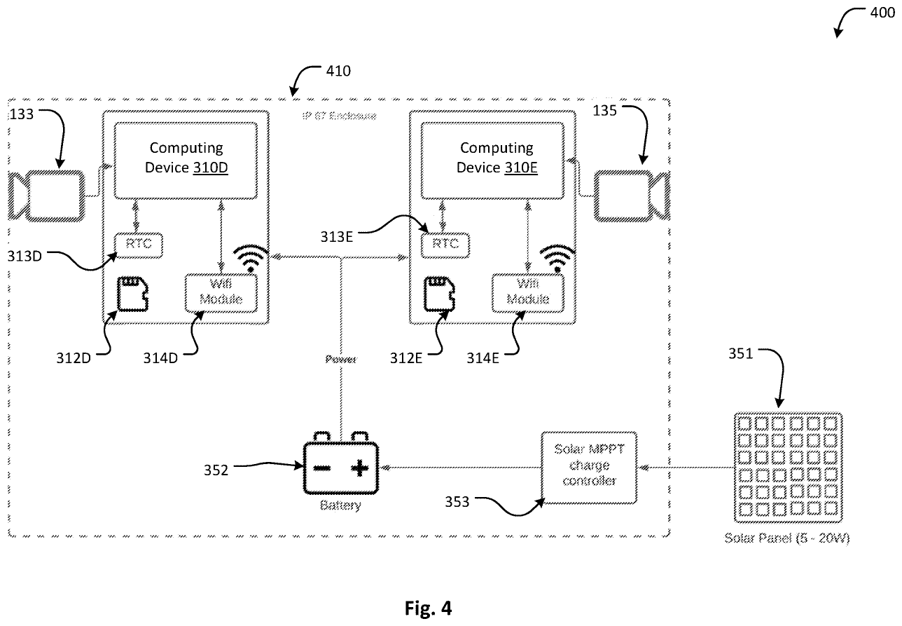

FIG. 4 is a schematic diagram of an exemplary monitoring system 400 according to some embodiments. The exemplary monitoring system 400 may be or include a kit or part of a kit of components that may be assembled and deployed in a post or a fixture in an urban area to performing monitoring operations based on images. System 400 comprises an enclosure 410 that houses two computing devices 310, shown as 310D and 310E, in an example. Enclosure 410 may secure the internal components from dust and/or water ingress. In some embodiments, enclosure 410 may be an IP67 rated enclosure. Computing devices 310D and 310E are configured to communicate with camera sensors 133 and 135 respectively. Each of the camera sensors 133 and 135 have a different field of view. WiFi modules 314D and 314E in the enclosure 410 allow the computing devices 310D and 310E to wirelessly communicate with a gateway device, such as gateway device 360. A solar panel 351 (which may be the same as or similar to solar panel 116) external of enclosure 410 may be of the kit to provide power to charge battery 352 through a charge controller 353. Also provided in monitoring system 400 are storage 312D and 312E for storing data or output of computations performed by the computing device 310D or 310E respectively. A real-time clock (RTC) 313, for example as shown by first and second RTCs 313D, 313E in FIG. 4, may be provided to provide clock/timing inputs to the computing devices 310D, 310E. Each of computing devices 310D and 310E may be part of respective sub-enclosures that also include storage devices 312D, 312E, RTCs 313D, 313E and WiFi modules 314D. 314E.

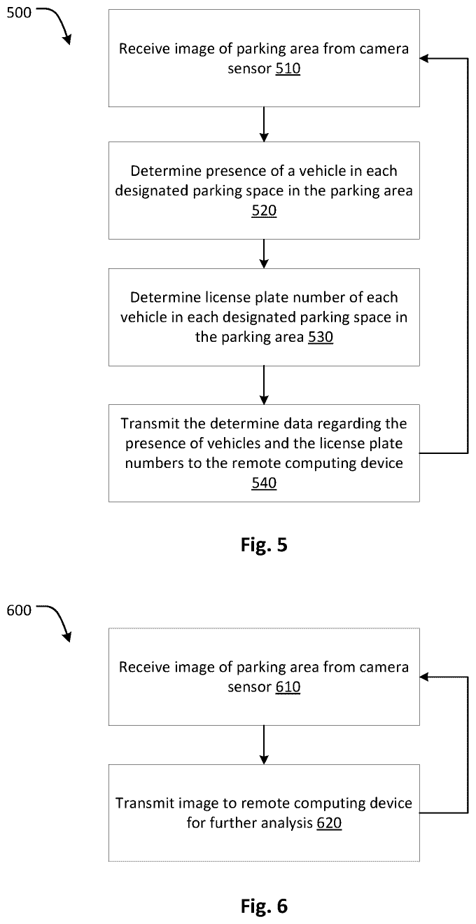

FIG. 5 is a flow chart illustrating a method 500 of urban monitoring implemented by the exemplary system of FIG. 1. Method 500 relates to a method of monitoring a parking area in the vicinity of post 120. Method 500 may be performed by the computing device 310 in coordination with the rest of the components of the monitoring system 100. At 510, the computing device 310 may receive images or image data from any one or more of the camera sensor(s) 133, 135, 137. The computing device 310 may comprise program code to initiate the capture of an image by the camera sensor(s). Alternatively, the computing device 310 may receive a continuous video or an image feed from the camera sensor(s). The image data may relate to data of a parking area in the vicinity of post 120.

At 520, the object detection module 324 of the computing device 310 may process the image data received at 510 to determine the presence of one or more vehicles in the image. Memory 320 of the computing device 310 may also comprise metadata regarding an identity or identifier associated with each distinct parking space in the vicinity of post 120. At 520, the object detection module may also determine an identifier of a specific parking space where a vehicle may have been detected in the image. The detection of one or more vehicles and/or a parking identifier associated with a parking region or area of the detected vehicles may be a part of an edge computing output generated by the computing device 310.

At 530, the computing device 310 may process the image data received at 510 to determine a license plate number of each vehicle detected at 520. The detection of the license plate number may include detection of an image region corresponding to a license plate by the object detection module 324. The image region corresponding to the license plate may be processed by a character recognition component of the object detection module to determine the license plate number of the detected vehicles. The determined license plate number may form part of an edge computing output generated by the computing device 310.

At 540, the computing device 310 may transmit the edge computing output determined at 520 and 530 to the remote computing device 380. The remote computing device 540 may process the received edge computing output to determine compliance of a vehicle with the parking conditions of the parking area in the vicinity of post 120. In some embodiment, the computing device 310 may determine compliance of a vehicle with the parking conditions of the parking area in the vicinity of post 120 and transmit the determined compliance output to the remote computing device 380. At 540, the computing device 310 may also transmit timestamp information associated with the time at which the image received at 510 was captured.

Method 500 of FIG. 5 may be performed at a frequency suitable for adequate monitoring of the parking area. Method 500 may be performed at a frequency of every 30 seconds, every 1 minute, every 10 minutes, every 15 minutes, every 30 minutes, or other fixed or variable interval, for example.

FIG. 6 is a flow chart illustrating a method 600 of urban monitoring implemented by the exemplary system of FIG. 1. Method 600 relates to a method of monitoring a parking area in the vicinity of post 120. Method 600 may be performed by the computing device 310 in coordination with the rest of the components of the monitoring system 100. In contrast with method 500 of FIG. 5, method 600 involves the periodic transmission of images captured by the camera sensors of the monitoring system 100 to the remote computing device 380 wherein the image processing operations are performed to determine compliance of a vehicle with parking conditions.

At 610, the computing device 310 may receive images or image data from any one or more of the camera sensor(s) 133, 135, 137. The computing device 310 may comprise program code to initiate the capture of an image by the camera sensor(s) 133, 135, 137. Alternatively, the computing device 310 may receive a continuous video or an image feed from the camera sensor(s) 133, 135, 137. The image data may relate to data of a parking area in the vicinity of post 120.

At 620, the computing device 310 transmits the image data received at 610 to the remote computing device 380. The remote computing device 380 may then perform image processing operations to determine the presence of vehicles in the image data and compliance of the detected vehicles with parking conditions. According to method 600, the edge computing output may include image data or images captured by the camera sensors of the monitoring system 100. In some embodiments, the image data may be compressed before transmission to reduce the network bandwidth requirement.

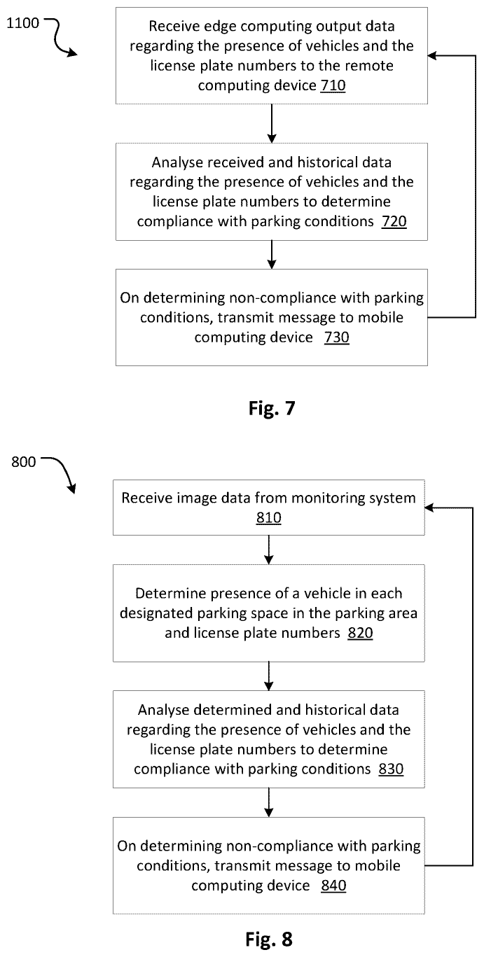

FIG. 7 is a flow chart illustrating method 700 of urban monitoring implemented by the exemplary system of FIG. 1. Method 700 relates to a method of monitoring a parking area in the vicinity of post 120. Method 700 may be performed by the remote computing device 380 in coordination with the computing device 310. In particular, method 700 may be performed by the remote computing device 380 in coordination with method 500 performed by computing device 310.

At 710, the remote computing device 380 receives edge computing output data from the computing device 310. The edge computing output data may include data regarding the presence of vehicles and the license plate numbers of the detected vehicles. The edge computing output data may also include data regarding parking area identifiers associated with each detected vehicle and timestamp information.

At 720, the remote computing device 380 may analyse the edge computing output data received at 710 and previously received edge computing output data to determine compliance of vehicles with one or more parking conditions associated with the parking area. Determination of compliance may include the determination of whether an identified vehicle has exceeded a predefined maximum parking duration, for example.

At 730, the remote computing device 380 may transmit a message to the mobile computing device 385. The transmitted message may include data regarding the parking location identifier, a vehicle identification number and an indication of compliance or noncompliance with a parking condition, for example.

FIG. 8 is a flow chart illustrating a method 800 of urban monitoring implemented by the exemplary system of FIG. 1. Method 800 relates to a method of monitoring a parking area in the vicinity of post 120. Method 800 may be performed by the remote computing device 380 in coordination with the computing device 310. In particular, method 800 may be performed by the remote computing device 380 in coordination with method 600 performed by the computing device 310.

At 810, the remote computing device 380 receives image data from the computing device 310 transmitted at step 610 of method 600. At 820, the remote computing device 380 may perform image processing operations described with reference to steps 520 and 530 to determine the presence of a vehicle in each designated parking space in the parking area and license plate numbers of each determined vehicle in the image data received at 810.

At 830, similar to step 720, the remote computing device 380 determines compliance of vehicles with one or more parking conditions associated with the parking area. At 840, similar to step 730, the remote computing device 380 may transmit a message to the mobile computing device 385 via gateway device 360 and network 370. The transmitted message may include data regarding the parking location identifier, a vehicle identification number and an indication of compliance or noncompliance with a parking condition for example.

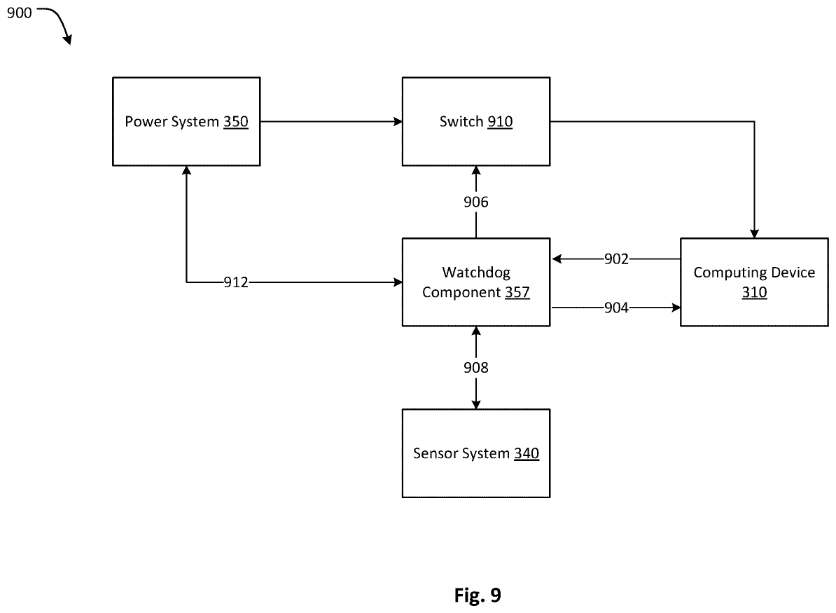

FIG. 9 is a block diagram 900 of an exemplary monitoring system 100 or 400 illustrating interactions of a watchdog component 357 with other components of the monitoring system 100 or 400. Block diagram 900 illustrates some of the interconnections of the watchdog component with other components of the monitoring system 100 or 400. The watchdog component comprises electronic circuitry configured to monitor signals from the power system 350, the computing device 310, and the sensor systems 340. The watchdog component is configured to process the received signals and determine or generate control signals responsive to the received signals. The control signals may be signals directed to the computing device 310 or a switch 910 that is part of system 100 or 400, for example.

Switch 910 controls the transmission of power from the power system 350 to the computing device 310. A control signal from the watchdog component 357 via the control link 906 may allow the watchdog component 357 to control the supply of power to the computing device 310, for example. Based on the control signal transmitted through link 906, switch 910 may be turned off or on.

Through communication link 902, the watchdog component 357 may receive signals from the computing device 310. Signals received through link 902 may indicate a status or health of the computing device 310. Through link 904, the watchdog component 357 may transmit control signals to the computing device 310. In some embodiments, the link 904 may allow the watchdog component 357 to reset the computing device 310 by transmitting a reset signal to a reset pin of the computing device 310. Transmitting a reset signal may initiate a reset sequence in the computing device 310 to address faults or errors in the operation of the computing device 310.

The watchdog component 357 may also be configured to receive sensor data from one or multiple sensors of the sensor systems 340 over communication link 908. Based on the received sensor data, the watchdog component 357 may detect environmental conditions that are unsuitable for normal or safe operation of computing device 310. For example, through the temperature data generated by the temperature sensor 343, the watchdog component 357 may determine that the temperature is unsuitably high or unsuitably low to continue normal or safe operation of the computing device 310. Responsive to such temperature sensor data, the watchdog component 357 may turn off switch 910. The watchdog component 357 may perform a similar operation responsive to an indication of high humidity or other condition unsuitable for normal or safe operation of the computing device 310.

The watchdog component 357 may also receive signals indicating the status or health of the power system 350 over link 912. The signals from the power system 350 may indicate a low power capacity of the power system 350. The signals from the power system 350 may indicate instability in the power supplied by the power system 350. Responsive to indications of low power supply or instability in the power supply, the watchdog component 357 may turn off switch 910 to protect the computing device 310. In some embodiments, the watchdog component 357 may transmit a signal over link 904 to the computing device 310 indicating low power availability. Responsive to the signal indicating low power availability, the computing device 310 may switch its operations to a low power mode to conserve power and prolong its operation.

Each of the links 902, 904, 906, 908, 912 may be a wired or wireless communication connection according to known communication technologies through which commands and/or data can be passed to or from the watchdog component 357.

In some embodiments, the watchdog component 357 may periodically turn off and turn on the power supply to the computing device 310 to optimise the power consumption by the monitoring system 100. In some embodiments, the periodic turning on and off operations may be performed based on a predefined schedule. In some embodiments, the periodic turning on and off operations may be performed responsive to the fluctuations in the power supplied by or available to the power system 350.

Operations performed by the watchdog component 357 may prolong the lifespan of the various components of the monitoring system 100, in particular the lifespan of the computing device 310. Extending the lifespan of each monitoring system 100 may reduce the costs associated with repair or maintenance overhead associated with a large number of monitoring systems deployed across an urban area.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A monitoring system comprising a post with an inner wall defining an elongate cavity, at least a top part of the elongate cavity receiving therein at least part of a chassis, the chassis housing:
a computing device;
a communication subsystem accessible to the computing device to enable communication with a remote computing device;
a first camera sensor in communication with the computing device and arranged to capture images of an area near the post;
a power source configured to supply power to the computing device, the communication subsystem, and the first camera sensor;
wherein the first camera sensor is configured to capture images and make the images accessible to the computing device.

2. The monitoring system of claim 1, wherein the power source comprises a battery and the battery is configured to supply power to the computing device, the communication subsystem, and the first camera sensor.

3. The monitoring system of claim 2, wherein the power source further comprises a solar panel, wherein the solar panel is disposed on or mounted to the post and configured to charge the battery.

4. The monitoring system of claim 1, wherein the computing device comprises an image data processing module to process the captured images and determine an edge computing output.

5. The monitoring system of claim 4, wherein the edge computing output is transmitted by the communication subsystem to the remote computing device.

6. The monitoring system of claim 1, wherein an orientation of the first camera sensor is configurable to vary a field of view of the first camera sensor.

7. The monitoring system of claim 1, wherein the system further comprises one or more of: an audio sensor, a temperature sensor, a humidity sensor, an air quality sensor, a ground vibration sensor, a soil moisture sensor, a motion detection sensor, a Bluetooth radio.

8. The monitoring system of claim 1, wherein the computing device is in communication with a low power sensor, wherein the low power sensor is configured to detect occurrence of an activity of interest; and
responsive to the detection of occurrence of the activity of interest, the computing device is configured to initiate capture of images by the first camera sensor.

9. The monitoring system of claim 1, wherein the chassis further houses or is connected to a second camera sensor in communication with the computing device;
wherein the first camera sensor is configured to capture images of a first field of view and the second camera sensor is configured to capture images of a second field of view.

10. The monitoring system of claim 9, wherein the first field of view partially overlaps with the second field of view; and
the computing device is configured to perform data fusion operations on the images captured by the first camera sensor and the second camera sensor to determine an inference regarding an event of interest in the captured images.

11. The monitoring system of claim 10, wherein the inference regarding an event of interest in the captured images includes an inference of detection of an object.

12. The monitoring system of claim 11, wherein the object includes a vehicle and the inference further includes a vehicle identification number.

13. The monitoring system of claim 11, wherein the object includes a person and the inference further includes a face region of the person in an image captured by the first camera sensor or the second camera sensor.

14. The monitoring system of claim 9, wherein the first field of view is different from the second field of view.

15. The monitoring system of claim 1, wherein the monitoring system further comprises a watchdog component, the watchdog component being configured to:
receive power supply status signals from the power source; and
control supply of power to the computing device responsive to the received power supply status signals.

16. The monitoring system of claim 1, wherein the monitoring system further comprises a watchdog component, the watchdog component being configured to:
receive computing device status signals from the computing device;
process the received computing device status signals to determine a functional status of the computing device; and
transmit a reset signal to the computing device responsive to determining that the functional status of the computing device indicates a malfunction.

17. The monitoring system of claim 7, wherein the monitoring system further comprises a watchdog component, the watchdog component being configured to:
receive temperature data from the temperature sensor or humidity data from the humidity sensor;
process the received temperature data or humidity data to determine whether temperature or humidity conditions exist that are unsuitable for operation of the computing device; and
terminate supply of power to the computing device responsive to the determining that the conditions are unsuitable for operation of the computing device.

18. A system for urban sensing, the system comprising
a chassis housing:
a computing device;
a communication subsystem accessible to the computing device, the communication subsystem accessible to the computing device to enable communication with a remote computing device;
at least a part of a camera sensor in communication with the computing device;
at least a part of a power source configured to supply power to the computing device, the communication subsystem, and the camera;
wherein the camera sensor is configured to capture images and make the images accessible to the computing device; and
wherein at least a part of the chassis is configured to be received within an elongate cavity defined in a post.

19. The system of claim 18, wherein the chassis is slideably receivable in the elongate cavity while allowing the camera sensor to capture images of a vicinity of the post.

20. A system for urban sensing, the system comprising:
a first computing device in communication with a first communication subsystem and a first camera sensor, wherein the first camera sensor is provided on a first post;
a second computing device in communication with a second communication subsystem and a second camera sensor, wherein the second camera sensor is provided on a second post;
wherein the first and second communication subsystems enable communication between the first and second computing devices; and
wherein the first computing device is configured to receive data captured by the second camera sensor and perform data fusion operations using the data captured by the first camera sensor and the data captured by the second camera sensor.

21. A method of providing a kerbside communication network, the method comprising:
providing a plurality of systems for urban sensing in a plurality of posts on a kerbside;
wherein a communication subsystem of each of the plurality of systems for urban sensing is configured to communicate with at least one proximate communication subsystem provided in an adjacent post.

22. A system for urban sensing, the system comprising:
a first post and a second post adjacent to the first post;
a first camera sensor provided in the first post and a second camera sensor provided in the second post;
a computing device configured to receive images from the first camera sensor and the second camera sensor;
wherein the first camera sensor captures images of a first field of view, and the second camera captures images of a second field of view;
wherein the first field of view partially overlaps with the second field of view;
wherein the computing device is configured to process the images received from the first camera sensor and the second camera sensor and perform data fusion operations of the received images to determine an inference regarding an activity of interest in the received images based on an output of the data fusion operations.

23. A method of urban monitoring, the method comprising:
providing the monitoring system of claim 1 in an urban area;
capturing images from a camera sensor of the monitoring system;
processing the captured images by the computing device of the monitoring system to perform urban monitoring.

24. The method of claim 23, wherein processing the captured images comprises processing the captured images to detect objects of interest in the captured images.

25. A method of urban monitoring, the method comprising:
providing the monitoring system of claim 1 in an urban area;
capturing images from a camera sensor of the monitoring system;
transmitting captured images to a remote computing device via the communication subsystem.
